(19) United States
(12) Patent Application Publication
(10) Pub. No.: US 2011/0226553 A1
(43) Pub. Date: Sep. 22, 2011

(54) OBSERVATION STAND AND METHOD OF OBSERVING OBJECTS

(76) Inventor: Melvin Mark Ekes, II, Coulterville, IL (US)

(21) Appl. No.: 12/728,654

(22) Filed: Mar. 22, 2010

(51) Int. Cl. A01M 31/02

(52) U.S. Cl. 182/188

(57) ABSTRACT

An observation stand. The stand removably attaches to an angled surface while presenting a platform horizontally with respect to the ground. The stand comprising a mounting assembly having a frame and a mounting plate connected to the frame. The frame includes a connector that is configured to removably secure to the angled surface. The mounting plate includes a center riser and a plurality of risers extending from the mounting plate in a direction outward from the angled surface. The stand further includes a frame removably connected to the mounting assembly. The frame has an adjusting plate that includes a center aperture and a plurality of surrounding apertures defined through the adjusting plate, wherein the center aperture is configured to connect with the center riser and the plurality of apertures are configured to rotatably connect with the plurality of risers.

### CROSS-REFERENCE TO RELATED APPLICATIONS

Not Applicable.

### STATEMENT REGARDING FEDERALLY SPONSORED RESEARCH

Not Applicable.

### BACKGROUND

The present disclosure relates to an observation stand, and in particular, relates to a stand that removably attaches to an angled surface while presenting a platform horizontally with respect to the ground.

Most wild animals are relatively shy and cautious, particularly of human presence. This is particularly true of animals which are commonly prey for other predators, with such prey animals generally developing keen senses of hearing, scent, and vision in order to sense potential predators with sufficient warning. Deer, for example, can be quite difficult to approach by hunters or photographers to provide a shot when considering the terrain, trees, brush, and other growth and factors, even with a rifle. This stalking task is made even more challenging for archery hunters.

Accordingly, hunters and observers have developed camouflage and various other aids in their cause. One factor which has been widely recognized is that nearly all land animals tend to restrict their vision to a relatively narrow field close to the horizontal, and spend very little of their attention looking above the horizontal. This is particularly true of deer and similar herbivores, which have very few predators that strike from above.

These factors have led to the development of tree stands for hunters, which provide several benefits for the hunter. Since hunting from the ground has inherent disadvantages, i.e., game can readily scent humans on the ground, and because of the limited visibility at ground level, the tree stand is ideal for the hunter wishing to gain a height and scent advantage over wilily game animals such as deer. Hunters attach the stand to the tree trunk to elevate the hunter, removing the hunter from the generally horizontal visual plane and scent capabilities of most game animals.

Existing stands are designed to attach to the vertical tree trunk. It is difficult, however, to arrange the stand so that the seating and footing components are level once attached to the tree trunk. Additionally, stands are not designed to attach to tree branches since the branches spread horizontally or at an angle from the tree trunk at some distance with respect to the ground. Placing hunter closer to tree branches, however, provides additional camouflage for the hunter. Further, current constructions are difficult and/or cumbersome to carry existing stands into the woods and erect in the tree. Hunters need a stable, light tree stand that can attach to a horizontal or angled tree branch while safely presenting a seat or foot platform horizontally with respect to the ground.

### SUMMARY

The present disclosure relates to a stand that removably attaches to an angled surface while presenting a platform horizontally with respect to the ground. The stand comprising a mounting assembly having a frame and a mounting plate connected to the frame. The frame includes a connector that is configured to removably secure to the angled surface. The mounting plate includes a center riser and a plurality of risers extending from the mounting plate in a direction outward from the angled surface.

The stand further includes a frame removably connected to the mounting assembly. The frame has an adjusting plate that includes a center aperture and a plurality of surrounding apertures defined through the adjusting plate, wherein the center aperture is configured to connect with the center riser and the plurality of apertures are configured to rotatably connect with the plurality of risers.

A seat assembly of the stand rotably connected to the frame. The seat assembly has a seat arm rotatably connected to the side frame member and having a seat cushion positioned on the seat arm. A foot assembly of the stand rotably connected to the frame. The foot assembly has a foot arm rotatably connected to the side frame member and has a foot support positioned on the foot arm, wherein the angular connection between the frame and the mounting assembly positions the seat cushion and foot support in a horizontal position with respect to the angled surface and the ground.

### BRIEF DESCRIPTION OF THE SEVERAL VIEWS OF THE DRAWINGS

FIG. 1 is a front elevational view of a stand constructed in accordance and embodying the present disclosure illustrating the stand connected to an angled surface in form of a tree branch;

FIG. 2 is front elevational view of the stand of FIG. 1 illustrating a frame, a seat assembly, a foot assembly, a back assembly and a mounting assembly shown in an angular position and shown in phantom lines in another angular position;

FIG. 3 is a rear view of the stand of FIG. 2;

FIG. 4 is a side elevational view of FIG. 2 further illustrating stabilizers connected to the frame and to the foot assembly;

FIG. 5 is a front view of the mounting assembly;

FIG. 6 is a rear view of the mounting assembly attached to the tree branch; and

FIG. 7 is a plan view of the stand in a folded position.

Corresponding reference numerals indicate corresponding parts throughout the several figures of the drawings.

### DESCRIPTION OF THE PREFERRED EMBODIMENT

The following detailed description illustrates the invention by way of example and not by way of limitation. The description clearly enables one skilled in the art to make and use the invention, describes several embodiments, adaptations, variations, alternatives, and uses of the invention, including what is presently believed to be the best mode of carrying out the invention.

The present disclosure relates to an observation stand. The stand is configured to removably attach to a vertical or horizontal or angled surface such a branch of a tree, while leveling components of the stand with respect to the ground once the stand has been established on the surface as desired. The stand can be used for observing any object e.g., bird and animal watching, hunting and photography, etc. as desired. However, for purposes of illustration only, the stand will be described for observing animals from an angled surface in the form of a tree branch.

Components of the stand can have a variety of cross sectional shapes such as, but not limited to, elliptical, oval, circular, triangular, square, rectangular, tubular or other appropriate geometric configuration. Components of the stand can be made of a variety of materials, such as, but not limited to, steel, cast iron, aluminum or plastic. The stand can be of any size to accommodate characterizations of users of any size and to accommodate support surfaces of varying cross-sectional shapes and sizes and varying angles with respect to the ground.

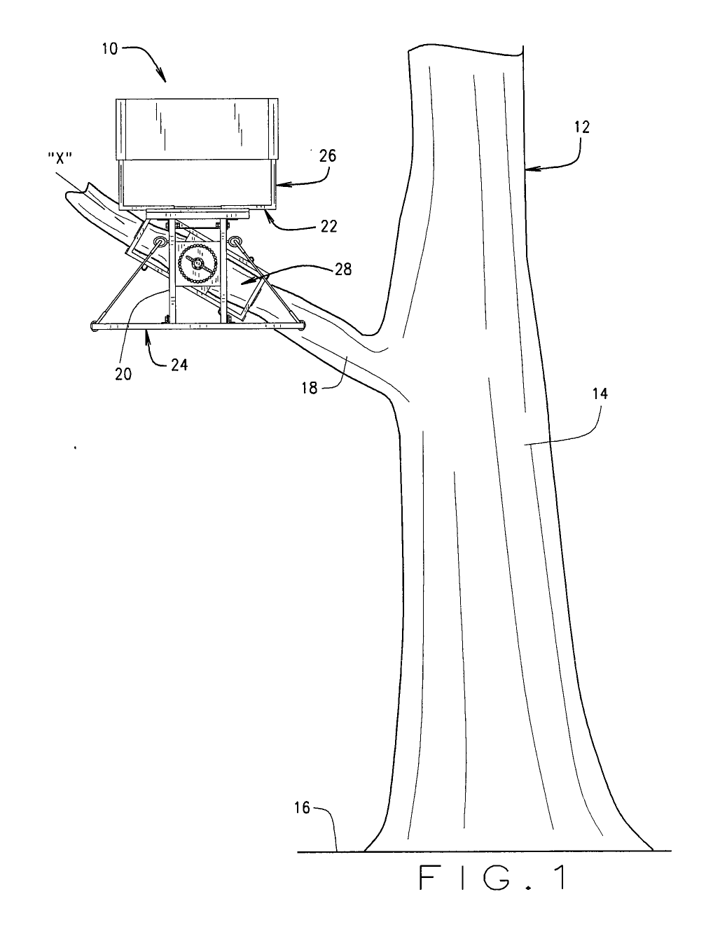

Referring now to the drawings, a stand 10 of the present disclosure is shown attached to a tree 12 (FIG. 1). As shown, the tree 12 includes a trunk 14 vertically rising from the ground 16. A branch 18 of the tree 12 extends upwardly from the trunk 14. As illustrated, the branch 18 extends along an axis “X at an angle” as measured from the trunk 14 and from the ground 16. The stand 10 comprises a frame 20, a seat assembly 22, a foot assembly 24, a back assembly 26 and a mounting assembly 28. The mounting assembly 28 allows a user to removably attach the frame 20 to the branch 18 through a plurality of angled or rotatable positions while leveling the seat assembly 22, the foot assembly 24 and the back assembly 26 with respect to the ground 16.

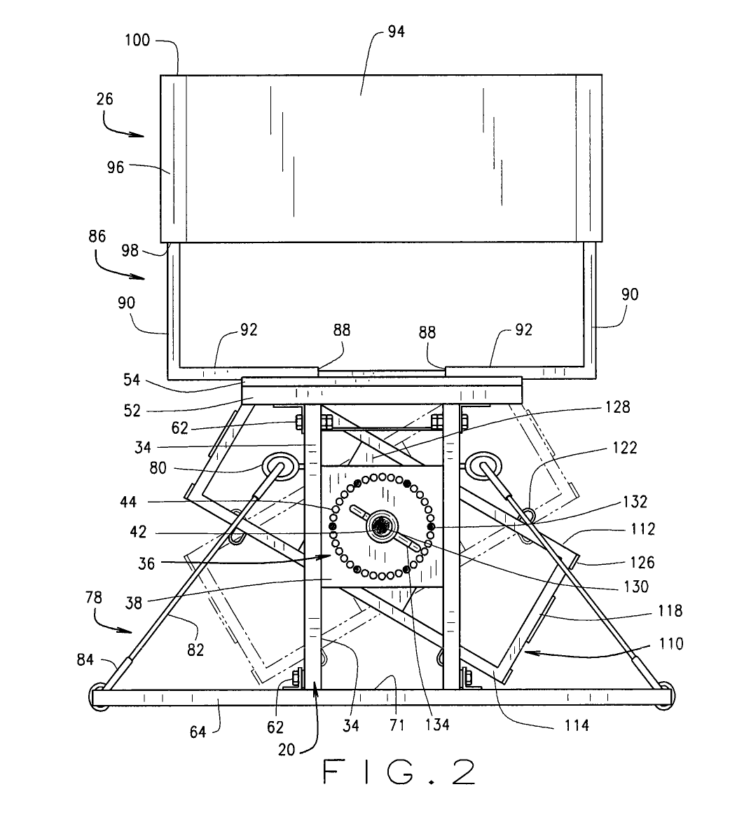

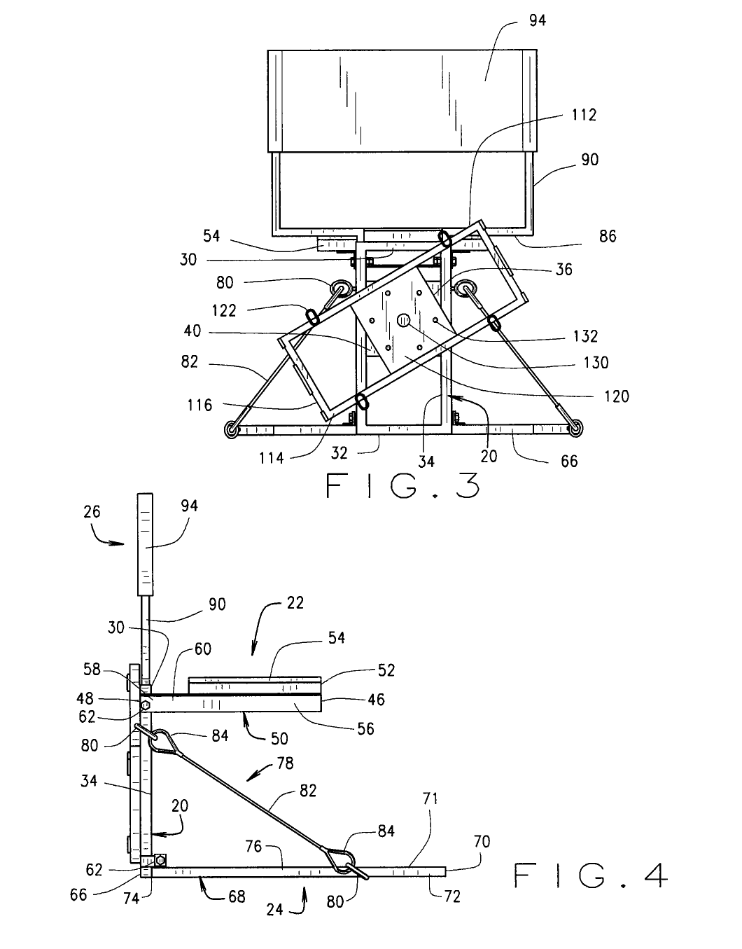

Turning to FIGS. 2 and 3, the frame 20 includes a top member 30, a bottom member 32, side members 34 and an adjusting plate 36 connected to top and bottom members 30, 32. The top member 30 and bottom member 32 have a length from about 4 inches to about 12 inches. The side members 34 have a length from about 6 inches to about 24 inches. In an embodiment, the top member 30, bottom member 32 and side members 34 comprise hollow tubular members that when connected form a rectangular configuration. In particular, the frame 20 positions the two spaced apart, parallel side members 34 connected by the cross top and bottom members 30, 32 aligned perpendicularly thereto at the proximate ends of the top and bottom members 30, 32. Top and bottom members 30, 32 connect to the side members 34 via a rigid connection such as, but not limited to, a weld.

The adjusting plate 36 of the frame 20 has a front side 38, a back side 40 and side walls connecting the front side 38 and the back side 40. In an embodiment, the adjusting plate 36 has a substantially square configuration with heights and widths from about 4 inches to about 12 inches respectively, and thicknesses from about 1/16″ to about ¼″. The adjusting plate 36 can include other configurations such as, for example, rectangular, triangular, or other polygonal or curvilinear cross section.

Located about the center of the plate 36, a center aperture 42 is defined through the front side 38 and back side 40. In an embodiment, the aperture 42 is circular shaped having a diameter from about ¼″ to about three inches. The adjusting plate 36 further has a plurality of apertures 44 defined through the front side 38 and the back side 40 at locations around the center aperture 42. The plurality of apertures 44 is located in a predetermined pattern around the center aperture 42. The predetermined pattern can be a circular pattern around the center aperture 42. In an embodiment, the apertures can include up to thirty six apertures 44 positioned around the center aperture 42. Any number of apertures 44 for connecting to the mounting assembly 28, as will be discussed, is intended to be within the scope of the present disclosure.

In this circular pattern, each aperture 44 is spaced equidistant from the center of the center aperture 42. In an embodiment, the length of each distance from the center aperture 42 is from about 2 inches to about 8 inches. Further, the diameter of each aperture 44 is from about ⅛″ to about 1 inch. The center lines of each aperture 44 are equidistant from the next adjacent aperture 44. In the embodiment of thirty six apertures 44 positioned around the center aperture 42, the center lines are positioned about 10° from the next adjacent aperture 44. The disclosed angular dimension, however, is for illustration purposes only.

Turning to FIG. 4 and referring to FIGS. 2 and 3, the seat assembly 22 of the stand 10 rotatably connects to the frame 20 in a plane which is perpendicular to the side members 34 of the frame 20. The seat assembly 22 comprises a front member 46, a back member 48, pivot arms 50, a seat support 52 and a seat cushion 54. Each pivot arm 50 has a front end 56, a back end 58 and a body 60 disposed therebetween. Near the front and back ends 56, 58, the front and back members 46, 48 respectively connect in a perpendicular orientation to the arms 50.

The back ends 58 of the pivot arms 50 rotatably connect with the sides 34 of the frame 20 at a location near the top member 30 of the frame 20. In an embodiment, connectors 62 such as bolts and associated nuts rotatably connect the pivot arms 50 to the frame 20. The pivot arms 50 of the seat assembly 22 are rotatable between a horizontal seating position and a vertical storage position as measured from the frame 20. Any rotatable connection for the arms 50 is intended to be within the scope of the present disclosure.

The seat support 52 attaches to the pivot arms 50 and is configured to support the seat cushion 54. In an embodiment, the support 52 comprises angle iron that is configured to support the seat cushion 54. In another embodiment (not shown), the seat support 52 comprises a grate. Still further, in an embodiment (not shown), the seat support 52 comprises cross rails aligned perpendicularly and connected to the pivot arms 50. Any member for supporting the seat cushion 54 is intended to be within the scope of the present disclosure.

Seat cushion 54 is preferably a cushion which is preferably generally rectangular in shape, although other desired shapes such, as a square-shaped cushion, could be used if desired. Furthermore, the seat cushion 54 could be a flexible woven material, such as a web or net, if desired. The seat cushion 54 is removable from the seat support 52 to provide observation advantages. For example, leaving the tree stand 10 at the base of a selected tree 12 overnight is a common practice. This reduces packing labor if the hunter decides to return later for another hunt. However, human scent is implanted and concentrated in the seat cushion 54 attached to the stand 10 which broadcasts the hunter's presence while the hunter is away from the stand site. The scent on the seat can inform animals in the area of the hunter's presence and ruin the stand site for future use. The detachable seat cushion 54 of the present disclosure can be quickly detached and carried home with the hunter each time the hunter leaves the stand 10.

As shown in FIG. 4, foot assembly 24 rotatably connects to the frame 20 in a plane which is perpendicular to the side members 34 of the frame 20. The foot assembly 24 comprises a front member 70, a back member 66, pivot arms 68 and a foot support 71. Each pivot arm 68 has a front end 72, a back end 74 and a body 76 disposed therebetween. Near the front and back ends 72, 74, the front and back members 64, 66 respectively connect in a perpendicular orientation to the arms 68.

The back ends 74 of the pivot arms 68 rotatably connect with the sides 34 of the frame 20 at a location near the bottom member 32 of the frame 20. In an embodiment, connectors 62 such as bolts and associated nuts rotatably connect the pivot arms 68 to the frame 20. The pivot arms 68 of the foot assembly 24 are rotatable between a horizontal observing position and a vertical storage position as measured from the frame 20. Any rotatable connection for the arms 68 is intended to be within the scope of the present disclosure.

The foot support 71 attaches to the back member 66, the front member 70 and the pivot arms 68. In an embodiment, the support 71 comprises a grate that is configured to support the user when the user stands on the support 71. In another embodiment (not shown), the foot support 71 comprises cross rails aligned perpendicularly and connected to the pivot arms 68. Any member for supporting the user is intended to be within the scope of the present disclosure.

The stand 10 further comprises flexible stabilizers 78 that are configured to support the rotatable foot assembly 24 in the horizontal position with respect to the frame 20. The stabilizers 78 include eyelets 80 connected to the side members 34 of the frame 20. These eyelets 80 are connected to the side members 34 at a position near the top member 30 of the frame 20. The eyelets 80 extend outward from the side members 34. The stabilizer 78 further comprises other eyelets 80 connected to the pivot arms 68 of the foot assembly 24. These eyelets 80 are connected to the pivot arms 68 at a position near the front 70 of the foot assembly 24. Eyelets 80 can be removably attached to the side members 34 and to the pivot arms 68.

The stabilizer 78 further comprises flexible connectors 82 that have looped ends 84. One looped end 84 is configured to removably connect with the frame eyelets 80 while the other looped ends 84 removably connect with the foot eyelets 80. Flexible connector 82 may be any conventional connector material well known in the art such as a cable, wire, rope, cord, chain, belt or the like, and preferably has a plastic polymeric coating thereon to prevent abrasion to the hands of the user. Further, any member for stabilizing the foot assembly 24 in the horizontal support position is intended to be within the scope of the present disclosure.

Referring to FIGS. 2 and 3, the back assembly 26 is configured to removably attach to the frame 20. In particular, the back assembly 26 removably inserts into top openings of the side frame members 20. The back assembly 26 comprises a pair of risers 86 and a back rest 94 that removably attaches to the risers 86. Each riser 86 includes a first arm 88, a second arm 90 and a body 92 disposed therebetween. The first arm 88 connects with one of the top openings of the frame 20. In an embodiment, the first arm 88 inserts within the top opening. Alternatively, the first arm 88 may slip around the top opening. Still further, the first arm 88 may telescopically connect with the opening of the frame 20.

The first arm 88 angles about 90 degrees from the body 92. The second arm 90 angularly bends beyond the body 92 in a direction that is co-planar with the first arm 88. In an embodiment, the second arm 90 angles about 90 degrees from the body 92. The body 92 is configured to suspend the second arm 90 at a position away and above the frame 20. As shown in FIG. 3, extending upward at an offset position from the frame 20 side members 34 are the pair of second arms 90. Each of the arms 88, 90 preferably lies co-planarly with the side frame members 34.

The back rest 94 comprises a substantially rectangular member having slots 96 positioned on opposing sides. The slots 96 include an open end 98 and a closed end 100. The open ends 98 are configured to removably accept the second arms 90 such that the second arms 90 contact the closed ends 100. In this position, the member rests on the second arms 90.

The back rest 94 is preferably a cushion which is preferably generally rectangular in shape, although other desired shapes such, as a square-shaped cushion, could be used if desired. Furthermore, the back rest 94 could be a flexible woven material, such as a web or net, if desired. Similar to the seat cushion 54, the back rest 94 is removable from the second arms 90 by the hunter to remove the hunter's scent when the hunter leaves for the outing.

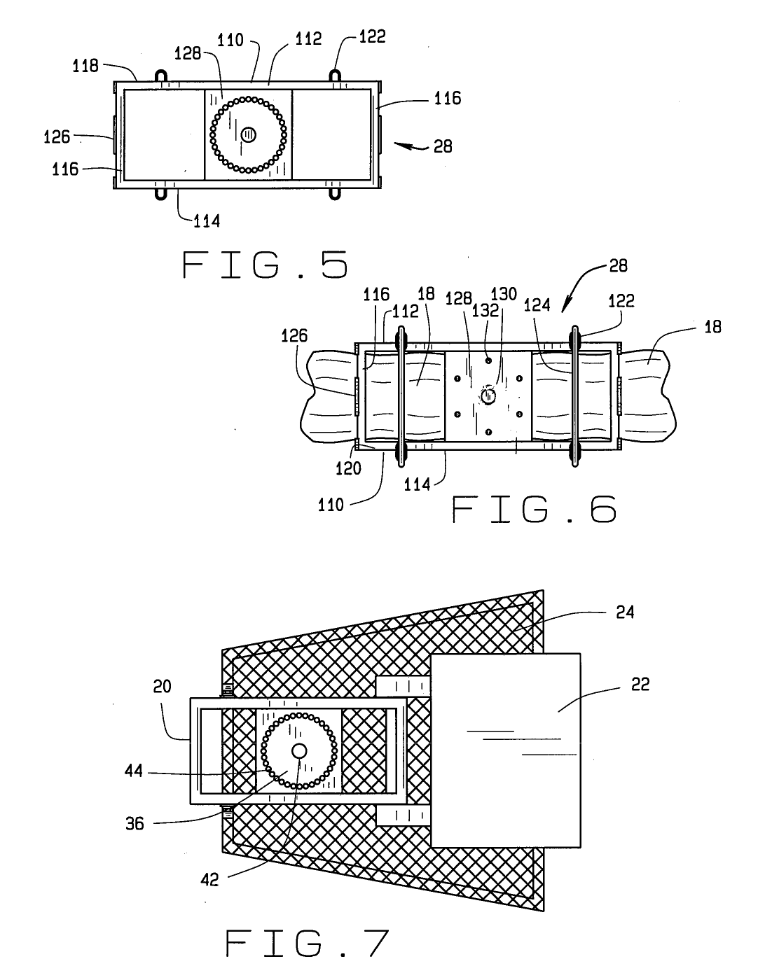

Turning to FIGS. 5 and 6, and referring to FIGS. 1-4, the mounting assembly 28 comprises a mounting frame 110 having a top member 112, a bottom member 114 and opposing side members 116. The members 112, 114 present a front face 118 and a back face 120. The side members 116 connect to the top member 112 and the bottom member 114 to form a substantially rectangular configuration. The mounting frame 110 can include other configurations such as, for example, square, triangular, or other polygonal or curvilinear cross section. The side members 116 have a length from about three inches to about twelve inches. The top member 112 and bottom member 114 have a length from about six inches to about twenty four inches.

Connectors 122 attach to the backside of the top member 112 and the bottom member 114. The top connectors 122 are spaced opposite the bottom connectors 122. In one form, connectors 122 are U-shaped projections extending beyond the top member 112 and the bottom member 114. The connectors 122 are sized and shaped to accept restraining straps 124(FIG. 6) that are positioned around the tree branch 18 as will be discussed. Any member for restraining the mounting frame 110 to the angled surface is intended to be within the scope of the present disclosure.

As shown in FIGS. 5 and 6, anchors 126 are positioned on the back side 120 of the side members 116, the top member 112 and the bottom member 114. The anchors 126 comprise a plurality of toothed members such as rectangular channels which bite into the tree branch 18 to aid in preventing the stand 10 from sliding thereon or rotating therearound. However, rectangular channels could be replaced if desired by other conventional tree contacting members known in the art such as blades or the like.

The mounting assembly 110 further comprises a mounting plate 128. The mounting plate 128 attaches to the back sides 120 of the top member 112 and the bottom member 114. The mounting plate 128 includes a central riser 130 that extends outward from a front side 118 of the mounting plate 128 in a perpendicular direction from the mounting plate 128. The central riser 130 has a length from one inch to about 8 inches. The central riser 130 has a fastener such as male threads dispersed along the axis of the riser 130.

The mounting plate 128 further has a plurality of risers 132 extending from the front side 118 at locations around the center riser 130. The risers 132 are located in a predetermined pattern around the center riser 130. The predetermined pattern can be a circular pattern around the center riser 130. In an embodiment, the risers 132 can include up to six risers 132 positioned around the center riser 130. Any number of risers 32 for connecting the mounting plate 128 to the adjusting plate 36, as will be discussed, is intended to be within the scope of the present disclosure.

In this circular pattern, each riser 132 is spaced equidistant from the center of the center riser 130. In an embodiment, the length of each distance from the center riser 130 is from about 2 inches to about 8 inches. Further, the height of each riser 132 is from about one inch to about 8 inches. The center lines of each riser 132 are equidistant from the next adjacent riser 132. In the embodiment of six risers positioned around the center riser 130, the center lines are positioned about 30 degrees from the next adjacent riser 132.

The center aperture 42 connects with the center riser 130. In particular, the center riser 130 is configured to insert into and through the central aperture 42 of the adjusting plate 36. The plurality of apertures 44 rotatably connect with a selected number of the plurality of surrounding risers 132. In particular, the surrounding risers 132 are configured to selectively insert into and through the surrounding apertures 44 of the adjusting plate 36. A handle 134 of the mounting assembly 28 removably connects with the central riser 130 to secure together the mounting plate 128 and the adjusting plate 36. As will be discussed, the user can selectively insert the surrounding risers 132 through the surrounding apertures 44 to position the mounting plate 128 through a plurality of rotatable or angular positions with respect to the frame 20. Since the predetermined pattern of the surrounding apertures 44 form a circle around the central aperture 42, the selective positioning of the risers 132 allows the mounting plate 128 to rotatably or angularly position through 360 degrees of movement with respect to the frame 20.

Referring to FIGS. 1-7, during use, the hunter positions the stand 10 in the storage position by folding the frame 20 over and on top of the foot assembly 24 and folds the seat assembly 22 over and on top of the frame 20. In the folded position, the hunter can easily transport the stand 10 to the hunting site. At the desired hunting site which has the angled surface such as the tree branch 18, the hunter unfastens the mounting assembly 28 from the frame 20. To unfasten the mounting assembly 28, the hunter releases or unscrews the handle 134 from the central riser 130 to release the mounting plate 128.

The hunter raises the mounting plate 128 toward the angled branch 18. At the desired location along the branch 18, the hunter positions the back side 120 of the mounting plate 128 co-linear along the branch 18 at the angle of the branch 18. Restraining straps 124 are inserted through the U-shaped connectors 122, around the tree branch 18 and fastened to the U-shaped connectors 122 to secure the mounting plate 128 to the branch 18. While receiving the restraining straps 124, the anchors 126 of the mounting plate 128 bite into the tree branch 18 to assist stabilizing the mounting plate 128 to the tree branch 18 at the angular orientation of the tree branch 18.

In the secured position on the tree branch 18, the center riser 130 and surrounding risers 132 extend outwardly from the mounting plate 128 and beyond the front of the tree branch 18. The user can conveniently align the center aperture 42 and the surrounding apertures 44 of the adjusting plate 26 with the extended center riser 130 and surrounding risers 132 of the mounting plate 128. The user can then selectively align the surrounding apertures 44 with the extended risers 132 such that the seat assembly 22, the foot assembly 24 and the back assembly 26 are oriented horizontally with respect to the ground 16. Thus, the user can rotate the frame 20 to angularly move the surrounding apertures 44 until the horizontal orientation of the seat assembly 22, the foot assembly 24 and back assembly 26 are achieved.

Upon selectively aligning the apertures 44 with the risers 132, the user moves the frame 20 and the adjusting plate 36 toward the mounting plate 128 to insert the center riser 130 through the center aperture 42 and to move the surrounding risers into the selected surrounding apertures 44. The user then fastens the handle 134 to the center riser 130 by screwing or locking the handle 134 to the center riser 130. This fastening secures or locks the frame 20 to the mounting plate 128. As shown, the frame 20 is attached to the angled branch 18 while the seat assembly 22, the back assembly 26 and the foot assembly 24 are oriented horizontally with respect to the ground 16.

The front members 46, 64 of the seat assembly 22 and the foot assembly 24 extend away from tree branch 18 into midair resulting in a downward directed torque on the frame 20. The torque is counteracted by the mounting assembly 28 that is removably attached to the tree branch 18. The effect of the forces acting on stand 10 cause to be urged against the tree branch 18.

The sharpened anchors 126 embed in or otherwise grip the tree branch 18. When such a stand 10 is secured to the tree branch 18 with the above-mentioned strap 124 or chain, and when a hunter is either standing on the platform or seated atop the seat, the moment or couple generated by the weight of the hunter offset from tree branch 18 causes the anchors 126 to “bite” into the branch 18, while the stand 10 is prevented from rotating due to the strap or chain 124 being secured to the branch 18. In this manner the stand 10 remains secured to the angled tree branch 18 while the seat assembly 22, the back assembly 26 and the foot assembly 24 are oriented horizontally with respect to the ground 16.

The dimensions and angular orientations disclosed are representative of an embodiment and not intended to limit the scope of the disclosure. In view of the above, it will be seen that the several objects of the disclosure are achieved and other advantageous results are obtained. As various changes could be made in the above constructions without departing from the scope of the disclosure, it is intended that all matter contained in the above description or shown in the accompanying drawings shall be interpreted as illustrative and not in a limiting sense.

I claim:

1. A stand for suspending a person substantially horizontal as measured from the ground while the stand is secured to an angled surface, the stand comprising:
a mounting assembly having a frame and a mounting plate connected to the frame, the frame includes a connector that is configured to removably secure to the angled surface along a co-linear axis of the angled surface, the mounting plate having a center riser and a plurality of risers extending from the mounting plate in a perpendicular direction from the angled surface;
a frame removably connected to the mounting assembly, the frame having a top member, a bottom member and opposing side members that connect together the top member and the bottom member, the frame further having an adjusting plate connected to the opposing side members, the adjusting plate includes a center aperture and a plurality of surrounding apertures defined through the adjusting plate, wherein the center aperture is configured to connect with the center riser and the plurality of apertures are configured to rotatably connect with a selected plurality of risers;
a seat assembly rotably connected to the frame, the seat assembly having a seat arm rotatably connected to the side frame member and having a seat cushion positioned on the seat arm; and
a foot assembly rotably connected to the frame, the foot assembly having a foot arm rotatably connected to the side frame member and having a foot support positioned on the foot arm,
wherein the rotatable connection between the frame and the mounting assembly positions the seat cushion and foot support in a horizontal position with respect to the angled surface and the ground.

2. The stand of claim 1 further comprising a back assembly having a back frame and a back covering which at least partially covers the back frame, the back frame including opposing back side members that are configured to removably connect with the top member of the frame.

3. The stand of claim 1 wherein the center riser is positioned in the center of the mounting plate.

4. The stand of claim 3 wherein the plurality of risers are positioned around the center riser.

5. The stand of claim 4 wherein the plurality of risers are positioned in a uniform pattern around the center riser.

6. The stand of claim 5 wherein the uniform pattern is a circular pattern.

7. The stand of claim 6 wherein the center aperture is positioned in the center of the adjusting plate.

8. The stand of claim 7 wherein the plurality of apertures are positioned around the center aperture.

9. The stand of claim 8 wherein the plurality of apertures are positioned in a uniform pattern around the center aperture to match the pattern of the plurality of risers.

10. The stand of claim 9 wherein the center riser is configured to insert through the center aperture.

11. The stand of claim 10 further comprising a handle that is configured to secure the center riser to the adjusting plate.

12. The stand of claim 9 wherein the plurality of risers insert through a selected plurality of apertures.

13. A stand for suspending a person substantially horizontal as measured from the ground while the stand is secured to an angled surface, the stand comprising:
a mounting assembly having a frame and a mounting plate connected to the frame, the frame includes a connector that is configured to removably secure to the angled surface along a co-linear axis of the angled surface, the mounting plate having a center riser and a plurality of risers extending from the mounting plate in a perpendicular direction from the angled surface;
a frame removably connected to the mounting assembly, the frame having a top member, a bottom member and opposing side members that connect together the top member and the bottom member, the frame further having an adjusting plate connected to the opposing side members, the adjusting plate includes a center aperture and a plurality of surrounding apertures defined through the adjusting plate, wherein the center aperture is configured to connect with the center riser and the plurality of apertures are configured to rotatably connect with a selected plurality of risers; and
a seat assembly rotably connected to the frame, the seat assembly having a seat arm rotatably connected to the side frame member and having a seat cushion positioned on the seat arm,
wherein the angular connection between the frame and the mounting assembly positions the seat cushion in a horizontal position with respect to the angled surface and the ground.

14. The stand of claim 13 wherein the center riser is positioned in the center of the mounting plate.

15. The stand of claim 14 wherein the plurality of risers are positioned around the center riser.

16. The stand of claim 15 wherein the plurality of risers are positioned in a uniform, circular pattern around the center riser.

17. The stand of claim 16 wherein the center aperture is positioned in the center of the adjusting plate and the plurality of apertures are positioned around the center aperture.

18. The stand of claim 17 wherein the plurality of apertures are positioned in a uniform pattern around the center aperture to match the pattern of the plurality of risers.

19. A method of suspending a person by a stand substantially horizontal as measured from the ground while the stand is secured to an angled surface, the method comprising:
mounting a plate along a co-linear axis of the angled surface;
positioning a center riser and plurality of surrounding risers of the mounting plate in a perpendicular direction from the angled surface;
rotatably connecting a frame to the center riser and plurality of surrounding risers; and
removably connecting a seat assembly to the frame wherein the rotatable connection of the frame to the center riser and the plurality of surrounding risers positions the seat assembly in a horizontal position with respect to the ground.

20. The method of claim 19 wherein rotatably connecting the frame to the center riser and the plurality of surrounding risers comprises inserting the center riser into a center aperture of the frame and inserting the plurality of surrounding risers into a plurality of surrounding apertures of the frame.
